(19) United States
(12) Patent Application Publication
(10) Pub. No.: US 2019/0372798 A1
(43) Pub. Date: Dec. 5, 2019

(54) SCALABLE FACILITY DATA MONITORING WITH SELF-INSTALLATION

(71) Applicant: Aquicore Inc., Washington, DC (US)

(72) Inventors: Logan Soya, Washington, DC (US); Roy Illingworth, Vienna, VA (US); Michael Donovan, Annandale, VA (US)

(73) Assignee: Aquicore Inc., Washington, DC (US)

(21) Appl. No.: 16/427,334

(22) Filed: May 30, 2019

Related U.S. Application Data
(60) Provisional application No. 62/678,514, filed on May 31, 2018.

(51) Int. Cl. H04L 12/28; G01D 4/00

(52) U.S. Cl. CPC H04L 12/2814; G01D 4/004; H04L 12/2832

(57) ABSTRACT

A scalable installation of facility data monitoring in a facility having one or more meters. In embodiments, a method and a system provide scalable installation through an application and a user-interface on a mobile device. The mobile device is coupled over a network to a remote online data monitoring service. The method includes installing a hub, installing one or more bridges including coupling the bridge(s) to one or more meters, connecting the installed bridge to the installed hub over one or more wireless communication links, and connecting the installed hub with the mobile device over a wireless communication link. In other embodiments, methods and systems provide scalable installation of facility data monitoring that includes enabling a user through a user-interface at the mobile device to enter information in response to the application on the mobile device communicating with the remote online data monitoring service.

### FIELD

The technical field of the present disclosure relates to facility monitoring, including utility, energy, equipment, and environmental monitoring.

### BACKGROUND ART

Many buildings and projects require electrical energy and include a combination of complex mechanical and electrical equipment to enable the successful daily operation of the site. Managers of buildings and projects have monitored utility and electrical consumption, along with equipment, environmental conditions to maintain these operations. For example, within energy consumption, building owners monitor electrical consumption with meters that sense voltage or current. This meter can be utilized to sense total current, overall energy consumption, and/or peak amounts of power usage within a period of time which is then used to generate monthly bills.

Such metering and monthly reporting however does not provide a real-time measure of power usage at different time intervals or by different components within a building. Moreover, most building managers do not have remote access to real-time information about utility usage, equipment status, or environmental conditions within the building. Managers are often limited to visibly observing the meter or equipment operation on site which may be physically inconvenient when located in basements or fixed locations and result in missing actions that could be taken to operate the building more effectively, or prevent failures from occuring. Physical inspection at a particular times also does not provide information sufficient to manage building operations over a time period. Even if additional meters or equipment displays are provided, visible inspection of different current meters, equipment, or environmental sensors is time-consuming and also does not provide information sufficient to provide for optimal building operations.

Some buildings have local network solutions with onsite servers installed to process data sent from existing meters and equipment in the buildings over cabling to the onsite servers. Reports are then generated on applications installed on computers at the building. Installing such local network solutions and enterprise applications, and operating onsite servers however is time consuming and cost-prohibitive for many building owners.

Wireless meters and wireless networks may be used to send data from meters, equipment, and other sensors wirelessly. However, conventional approaches to the installation of wireless devices are also complex and can take weeks to complete before a user can access their facility data. For example, in one conventional approach a project engineer is needed to carry out a multi-stage installation process over the course of months. In this approach, project engineers go on site to scope a building. This scoping work involves locating and taking inventory of existing utility meters, sub-meters, solar installations, or other facility equipment where remote monitoring is desired. Then a project engineer coordinates an installation of networking equipment to connect to those devices through the use of a certified contractor. While this installation is happening the project engineer is keeping the customer up to speed through email. For remote facility monitoring to be provided, the project engineer has to manually provide installation data about the newly installed devices to an data monitoring service. The data monitoring service then has to create new database records to reflect the installation.

Once the contractor finishes the device installation, the process of commissioning must occur to validate that the remote data is reporting accurately. This involves asking the customer to provide certain information like manual readings but in many cases a building manager maybe disengaged or unfamiliar with the work being performed by the contractor, and as a result, may require additional on-site visits to validate the data quality of the remote monitoring.

After the commissioning process happens if any issues arose then the project engineer is responsible for finding the root cause and fixing it. Once validation occurs the installation is complete. Not only do conventional installations take weeks to complete and require professional engineers to install, they are also limited by the initial project parameters. This makes it difficult to scale an installation to accommodate more equipment and to accommodate different types of equipment.

### BRIEF SUMMARY OF THE INVENTION

The inventors recognized that what is needed is a scalable installation process for remote data monitoring within a facility. Furthermore, a scalable installation process that can be carried out by end users in real-time, as equipment is being installed on site, without specialized training or knowledge is needed.

Embodiments of the present disclosure relate to providing a scalable self-installation of facility data monitoring. For example, scalable self-installation of facility data monitoring can be provided in a building or project having one or more meters, equipment, or environmental sensors. In an embodiment, a method provides scalable self-installation through an application and a user-interface on a mobile device. The mobile device is coupled to communicate over a network to a remote online facility data monitoring service. The method includes installing a hub. The hub is configured to have a first wireless communication link for communicating over the network to a remote online data monitoring service and a second wireless communication link for communicating locally with the mobile device. The method further includes connecting the installed hub with the mobile device over the second wireless communication link, and using the application on the mobile device to communicate with the hub. This can include to verify the presence of the installed hub and check a signal strength of the hub for the first wireless communication link of the hub over the network to the remote online data monitoring service.

Further steps include installing at least one bridge including coupling the at least one bridge to one or more meters, using the application on the mobile device to communicate with the at least one installed bridge to verify the connection of each meter, and connecting the at least one installed bridge to the installed hub over one or more wireless communication links to form a network of devices. Additional steps include using the application on the mobile device to communicate with the at least one installed bridge to verify the connection of each installed bridge with the installed hub, and using the application on the mobile device to communicate with the remote online data monitoring service to initiate provisioning of the installed hub and the at least one installed bridge with the online data monitoring service.

The method further includes using the application on the mobile device to communicate with the remote online data monitoring service to generate an inventory of the one or more meters, and create a network topology representing the installation of the hub and the at least one bridge and coupled meters in the building.

In one feature, the method also includes prior to the installing steps, providing a self-installation kit to a user, wherein the self-installation kit includes the hub and the at least one bridge.

In another embodiment, a method for providing scalable self-installation of facility data monitoring in a building having one or more meters through an application and a user-interface on a mobile device coupled to communicate over a network to a remote online data monitoring service is provided. The method includes enabling a user through a user-interface at the mobile device to enter information in response to the application on the mobile device communicating with the remote online data monitoring service to: register with the remote online data monitoring service a hub and at least one bridge self-installed by a user in the building; generate an inventory of the one or more meters; and create a network topology representing the installation of the hub and the at least one bridge and coupled meters in the building.

Further embodiments relate to configuration. In an embodiment, a method for configuring an online data monitoring service to accommodate a scalable self-installation of facility data monitoring in a building having one or more meters and or on-site equipment is described.

In another embodiment, a system for configuring an online data management service to accommodate a scalable self-installation of facility data monitoring in a building having one or more meters is described. A storage database is configured to store information representative of the registered hub and at least one bridge self-installed in the building, the generated inventory of meters, and the created network topology.

In a further embodiment, a system for providing scalable installation of facility data monitoring in a building has a self-installation kit that includes a hub and at least one bridge; and an application which can be downloaded over a network to a mobile device having a user-interface. In one example, a user through a user-interface at the mobile device can enter information in response to the application operating on the mobile device and communicate with a remote online data monitoring service to: register with the remote online data monitoring service the hub and at least one bridge from the kit self-installed in the building by a user. The user through the user-interface at the mobile device can enter information in response to the application operating on the mobile device and communicating with a remote online data monitoring service to generate an inventory of the one or more meters; and create a network topology representing the self-installation of the hub and the at least one bridge and coupled meters in the building.

In one feature, the meters can be meters having different types of communication, whereby, the scalable installation of facility data monitoring in a building can be applied universally to remotely monitor energy from meters of different types. In an example, the different types of communication include pulse output signals and signals output according to a serial communication or other data communication protocol.

Further embodiments, features, and advantages of this invention, as well as the structure and operation and various embodiments of the invention, are described in detail below with reference to accompanying drawings.

### BRIEF DESCRIPTION OF THE DRAWINGS/FIGURES

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1A is a diagram that illustrates a system providing scalable installation of facility data monitoring in a building according to an embodiment.

FIG. 1B is a flowchart diagram of a method for providing scalable installation of facility data monitoring in a building according to an embodiment.

FIG. 2 is a diagram that illustrates an example installation in a building using a mobile device coupled to a remote online data monitoring service according to an embodiment.

FIG. 3 is a diagram that illustrates another example installation in a building according to a further embodiment.

FIGS. 4A-4T shows example screen displays that may be output by an application on a mobile device during an example self-installation.

FIG. 5 is a diagram of a network topology created for an installation that includes a hub device, one or more bridge devices, and meters according to an example.

FIG. 6A shows an example welcome screen display that may be output by an application on a mobile device after set up and registration of devices in an installation.

FIG. 6B shows an example facility data monitoring screen display that may be generated for a user to facilitate facility data monitoring of an installation.

FIG. 6C shows an example dynamic riser diagram that may be generated for a user to facilitate management of the facility data monitoring of an installation.

FIG. 7 is a block diagram of an exemplary electronic computing device that can be used to implement embodiments of the present invention.

The drawing in which an element first appears is typically indicated by the leftmost digit or digits in the corresponding reference number. In the drawings, like reference numbers may indicate identical or functionally similar elements.

### DETAILED DESCRIPTION OF EMBODIMENTS

Embodiments of the present disclosure relate to providing a scalable installation of facility data monitoring in a facility having one or more meters, equipment, or environmental sensors. Methods and systems can provide scalable installation through an application and a user-interface on a mobile device. Further methods and systems can allow configuring of an online data monitoring service to accommodate a scalable self-installation of facility data monitoring in a facility having one or more meters, equipment, or environmental sensors.

Examples of a facility, include but are not limited to, one or more buildings, such as a commercial, residential or public building, or collection of buildings. A facility can include for example, an apartment building, office building, office park, museum, laboratory, station, subway, university building, or campus. A facility can also be a project such as an exhibit, park space, pier, billboard, boardwalk, highway, or other construction requiring data monitoring. These examples are illustrative and not intended to be limiting.

### A. Self-Installation System

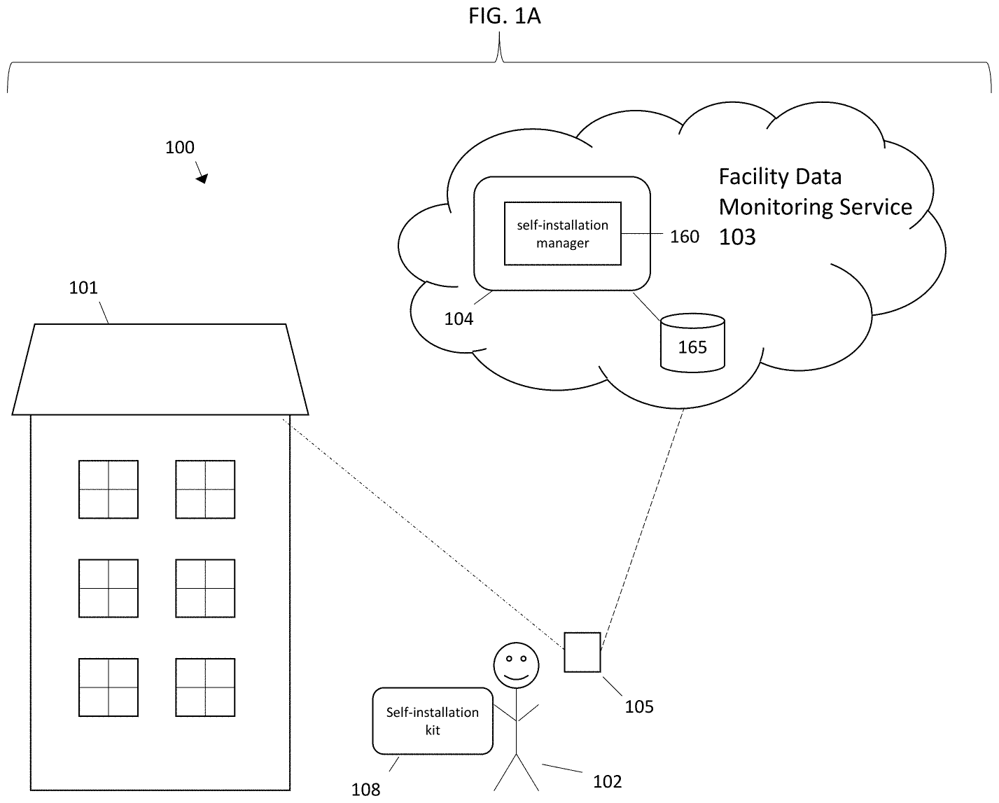

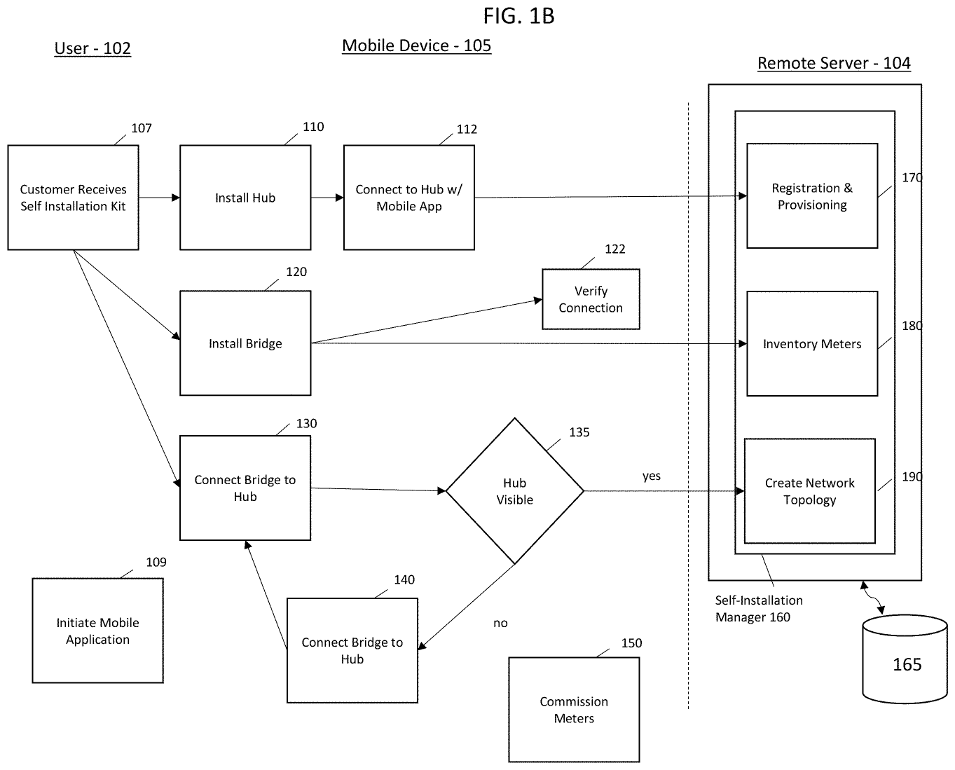

FIG. 1A is a diagram that illustrates a system 100 providing scalable installation of facility data monitoring in a building 101 according to an embodiment. System 100 includes a remote server 104 and self-installation kit 108. Remote server 104 includes a self-installation manager 160. A database storage 165 can be coupled to remote server 104.

In one feature, self-installation kit 108 can include a hub device and one or more bridge devices. For brevity, hub devices are also referred to simply as hubs and bridge devices are also referred to as bridges. A user 102 can access or open the kit 108 to access the hub and bridges and can self-install the hubs and bridges found in the kit in building 101. This self-installing can also include incorporating any existing equipment already installed in building 101 with those self-installed from kit 108.

In one feature, the hub and one more bridges provided in kit 108 are network devices that can be self-installed and configured in a network within building 101. In an embodiment, the hub device can be a wireless gateway device providing data communication in and out of a building to a remote server and locally with other networked devices (bridges) in the building. The hub may also control network operation for the networked devices in the building. In one example, a hub may contain a wireless radio that allows the hub to participate in a mesh network of networked devices in the building.

A bridge device (or simply bridge) can be a device that converts sensed output from a meter, equipment, or environmental sensor to data that can be digitized if needed and packetized and sent over an antenna to the hub or another bridge. The sensed output from a meter, equipment, or environmental sensor can be raw data or processed data output from the meter, equipment, or environmental sensor. Bridges once installed can communicate wirelessly with the hub. Once installed, bridges and the hub can form a network within building 101. Each networked device (bridge or hub) can connect to meters, sensors, equipment, or other devices for the purposes of collecting facility data. In one example, a bridge device can be configured to communicate locally with a mobile application and with the hub as described herein.

In one preferred implementation, the hub and bridges provided in kit 108 are a hub and bridges available from Aquicore, Inc. In this example, the Aquicore hub when operated acts as the coordinator of a mesh network which includes the bridges and the hub. As such the hub determines when each element of the network will transmit its payload to the hub within a polling period. The hub collects the data from the entire mesh network and delivers that data to a remote server for online facility data monitoring. Bridges once configured collect data from their locally connected devices (meters, sensors or other equipment) and transmit to the hub once per polling period. The operation is described in further detail below.

In further embodiments, kit 108 can include a hub device and other components for a hub such as a power supply, data cable (e.g. Ethernet cable), adaptor (e.g., USB adapter), and antenna. Kit 108 can also include a modem (such as a cellular modem) for coupling to the hub. Modem accessories such as a power supply and antennas (2) can also be provided in kit 108. Kit 108 can include a bridge device and other components for a bridge such as a power supply and antenna.

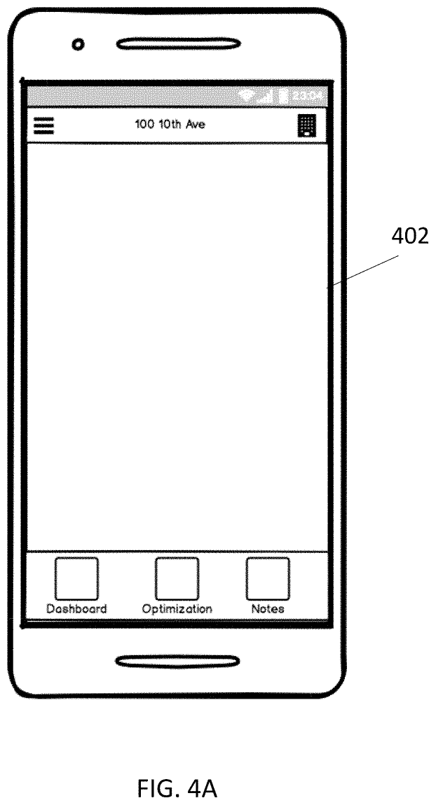

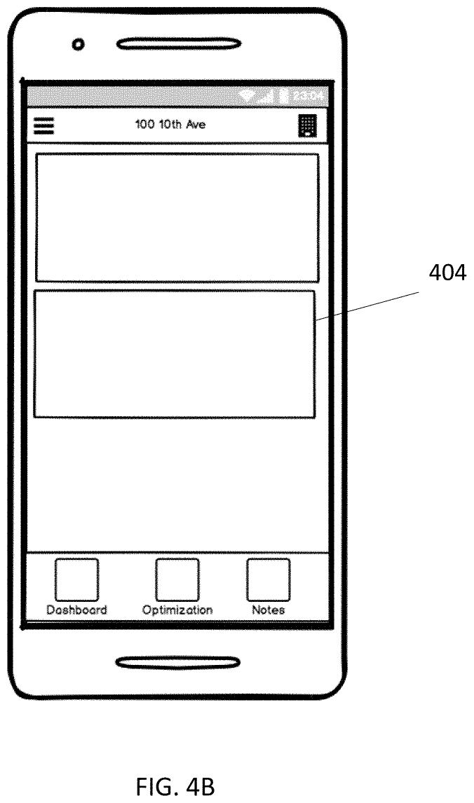

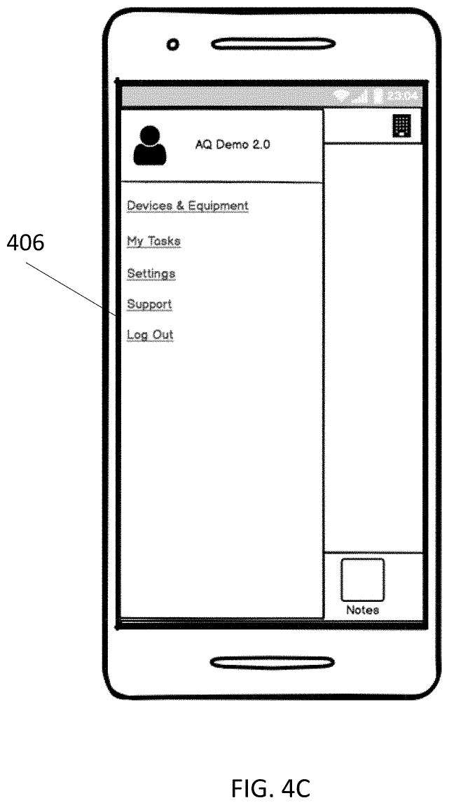

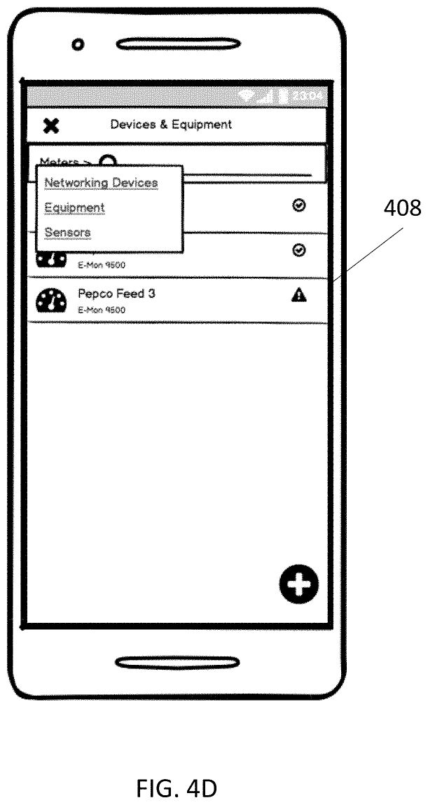

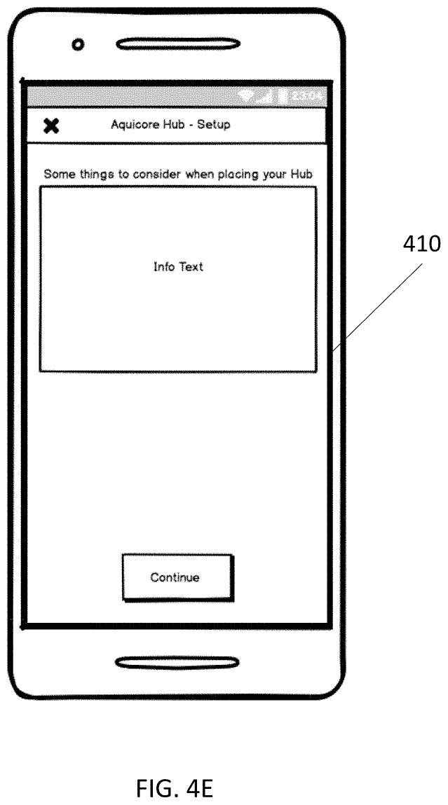

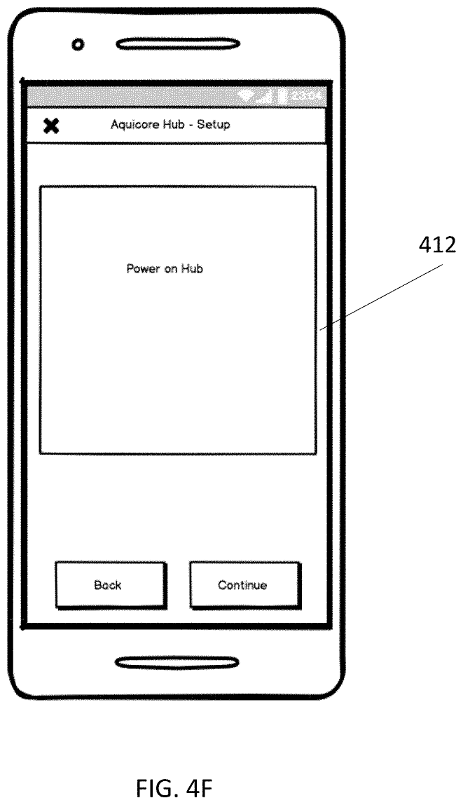

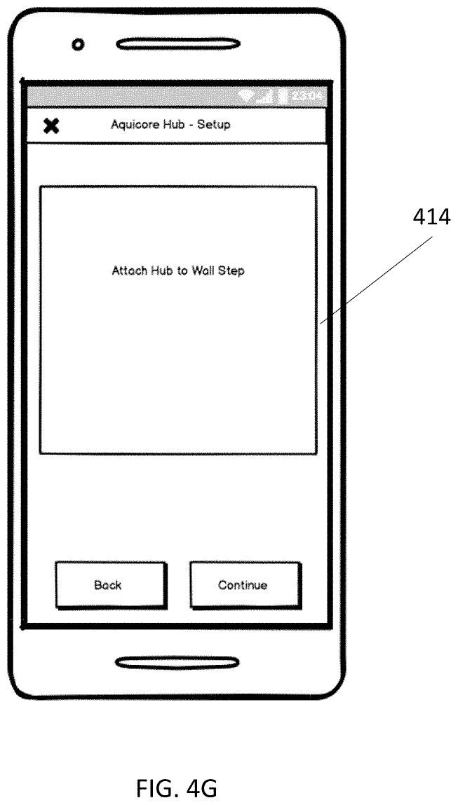

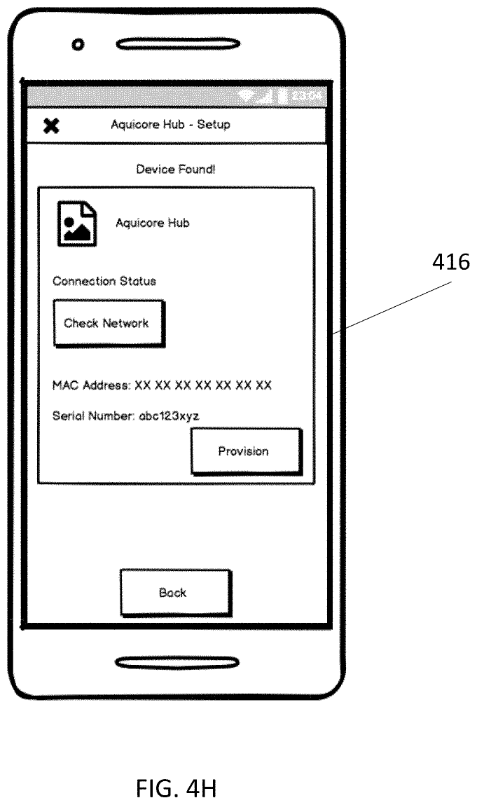

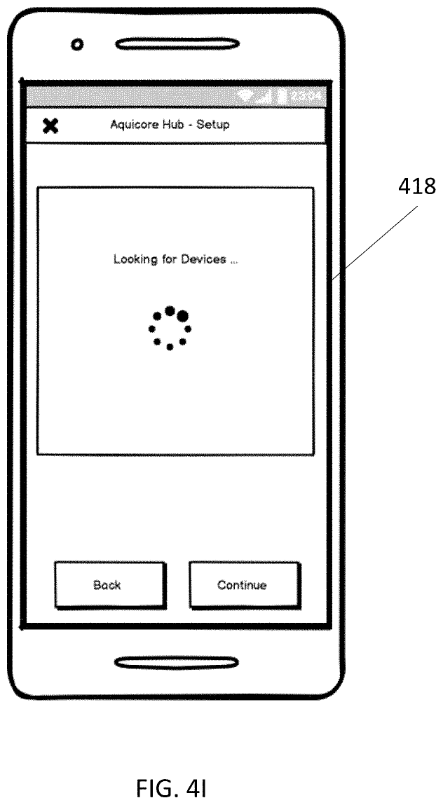

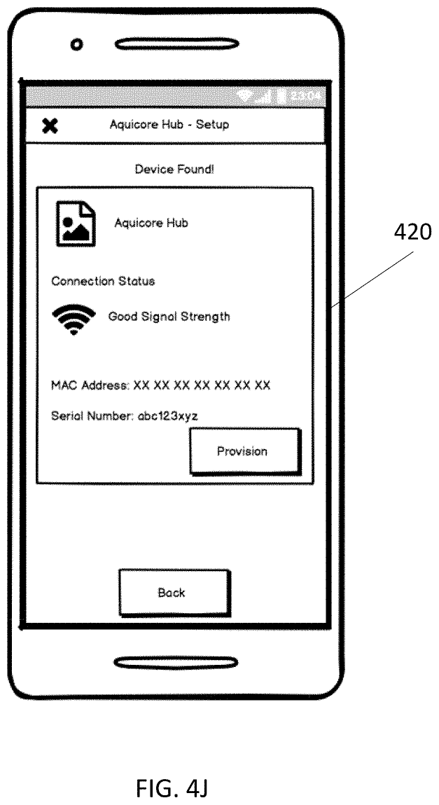

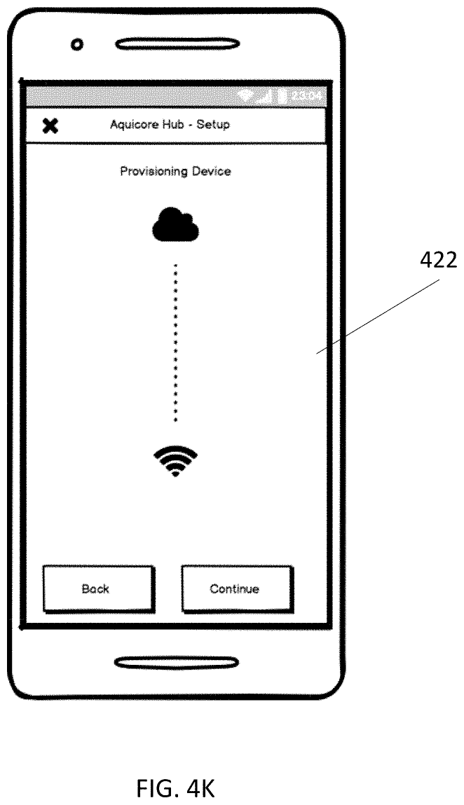

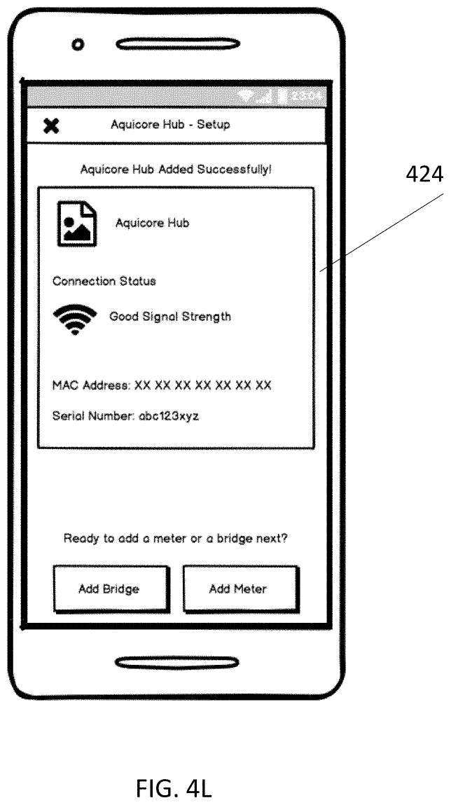

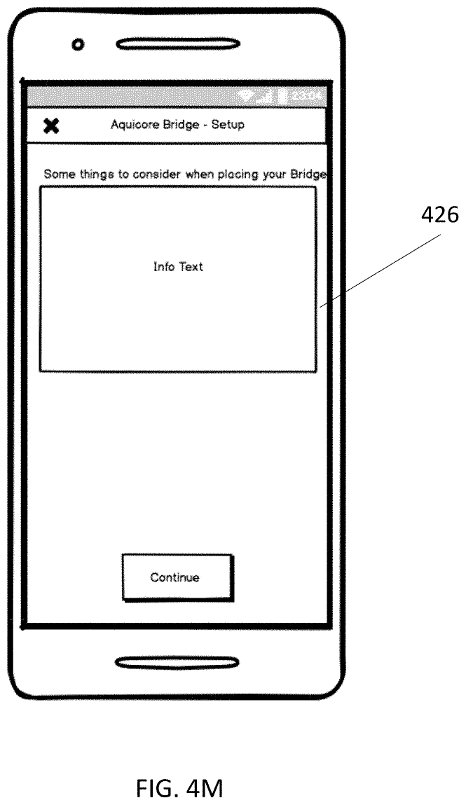

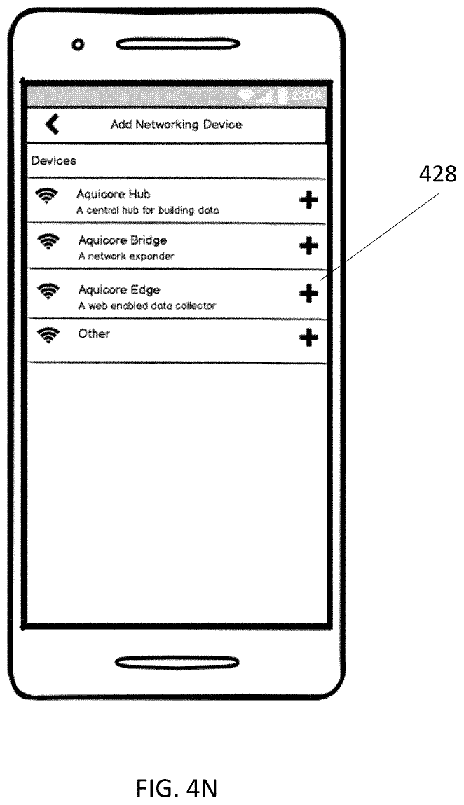

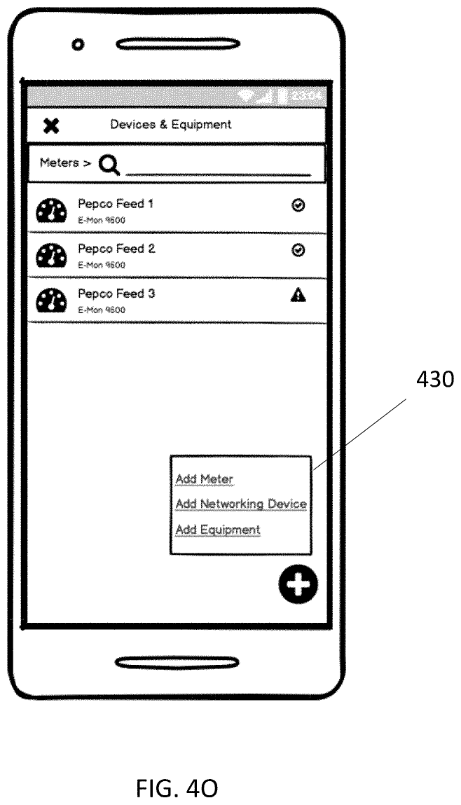

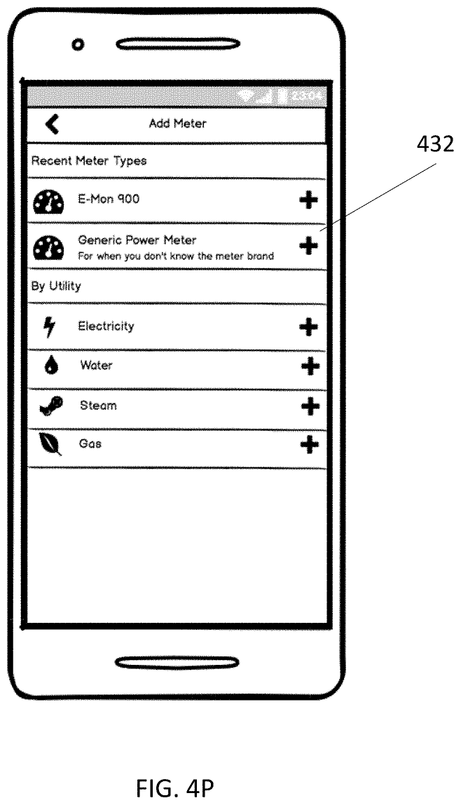

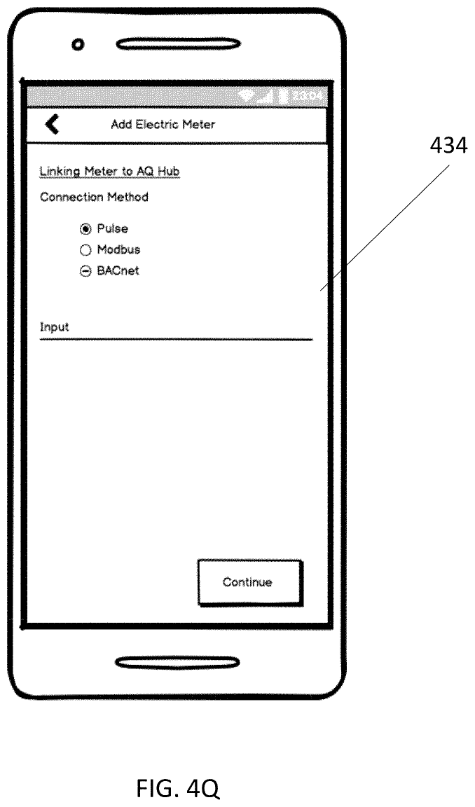

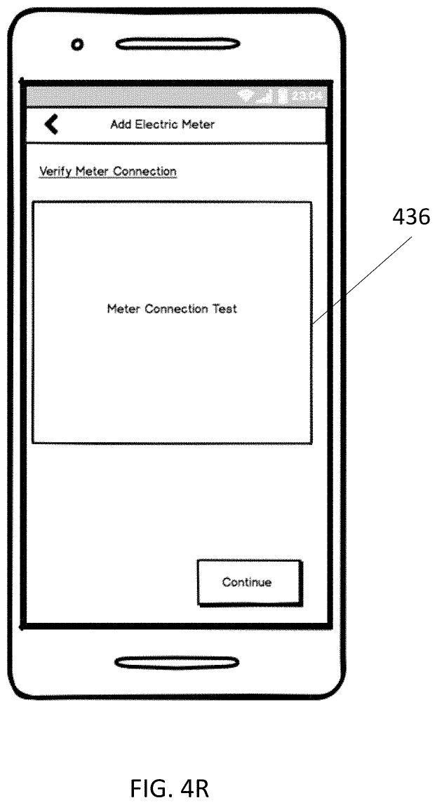

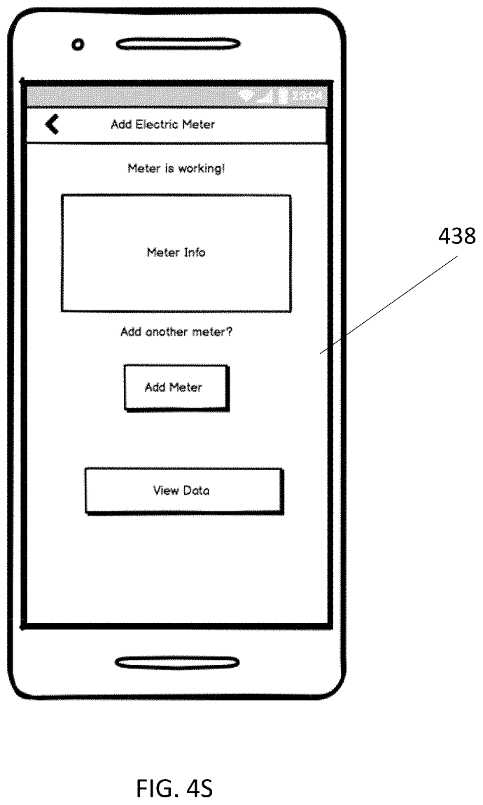

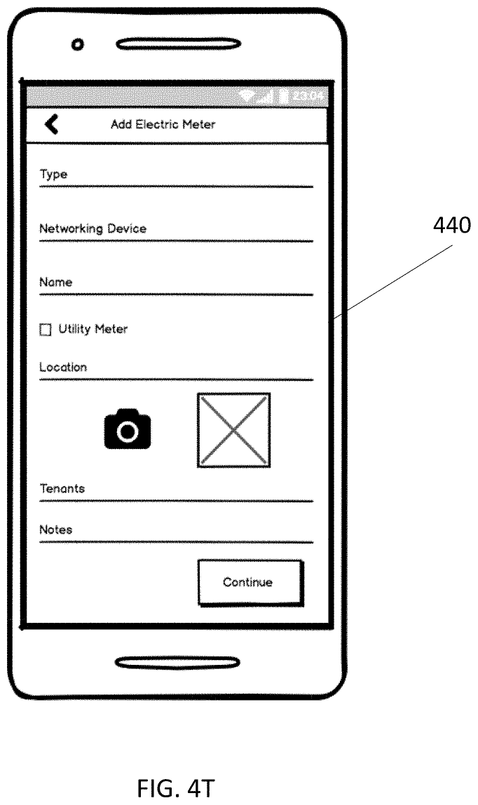

User 102 can use mobile device 105 to communicate over a network to remote server 104 and to communicate with hubs and bridges being installed. Mobile device 105 can include a mobile application for facilitating self-installation. For example, the mobile application can be downloaded or installed in mobile device 105 or accessed through a web browser. During a self-installing process, a user 102 can use the mobile application to obtain and input installation data regarding the hubs and bridges being self-installed. Instructions on self-installation can also be displayed or provided to user 102 through the mobile application. User 102 can also use the mobile application as part of the self-installation to communicate with remote server 104 to register and provision facility data monitoring components (e.g., meters, bridges, and hubs), inventory meters and create a network topology representing the self-installed network of facility data monitoring components. The mobile application can also be used to enable a user to initiate connection and signal strength tests. Further embodiments are described below and with respect to example user-interface and display screen outputs shown in FIGS. 4A-4T.

Mobile device 105 can be a smartphone, tablet, laptop, or other type of mobile computing device. Self-installation manager 160 can be implemented in software, firmware, hardware or any combination thereof and coupled to remote server 104. Self-installation manager 160 can communicate with a mobile application on mobile device 105 over a network or combination of networks such as the Internet. In one embodiment, self-installation manager 160 controls management of the self-installation at the server-side including controlling the carrying out of operations 170-190 described further below. Remote server 104 can be implemented in software, firmware, hardware or any combination thereof and can be implemented on one or more computing devices. Remote server 104 can be coupled to or include a web server and can be a single server or group of servers as part of server farm or cluster depending upon demand, capacity, workload or other design considerations.

Remote server 104 can be included as part of a facility data monitoring service 103. In one example, facility data monitoring service 103 can provide a centralized cloud-computing platform for managing energy usage. This can include but is not limited to the data management service described in commonly-owned U.S. pat. appl. Ser. No. 14/449,893, incorporated herein in by reference. For example, facility data monitoring service 103 and remote server 104 may include multiple components interworking with each other. One or more components of facility data monitoring service 103 including remote server 104 can be implemented in software, firmware, hardware, or any combination thereof. Depending upon the particular implementation, the components of facility data monitoring service 103 and remote server 104 can be implemented on the same or different server devices and can be made to operate with a variety of applications. Further, the components of facility data monitoring 103 and remote server 104 may be implemented on a distributed computing system. In an example embodiment, facility data monitoring 103 with remote server 104 may include an architecture distributed over one or more networks, such as, for example, a cloud computing architecture. Cloud computing includes but is not limited to distributed network architectures for providing, for example, software as a service (SaaS), infrastructure as a service (IaaS), platform as a service (PaaS), network as a service (NaaS), data as a service (DaaS), database as a service (DBaaS), backend as a service (BaaS), test environment as a service (TEaaS), API as a service (APIaaS), integration platform as a service (IPaaS), etc.

Storage database 165 for example may be a database platform running database management software available from an organization such as a commercial vendor or open source community. Various database platforms may include, but are not limited to, Oracle, Sybase, Microsoft SQL Server, MySQL, PostgreSQL, IBM DB2, Informix, and SQLite.

### B. Self-Installation Operation

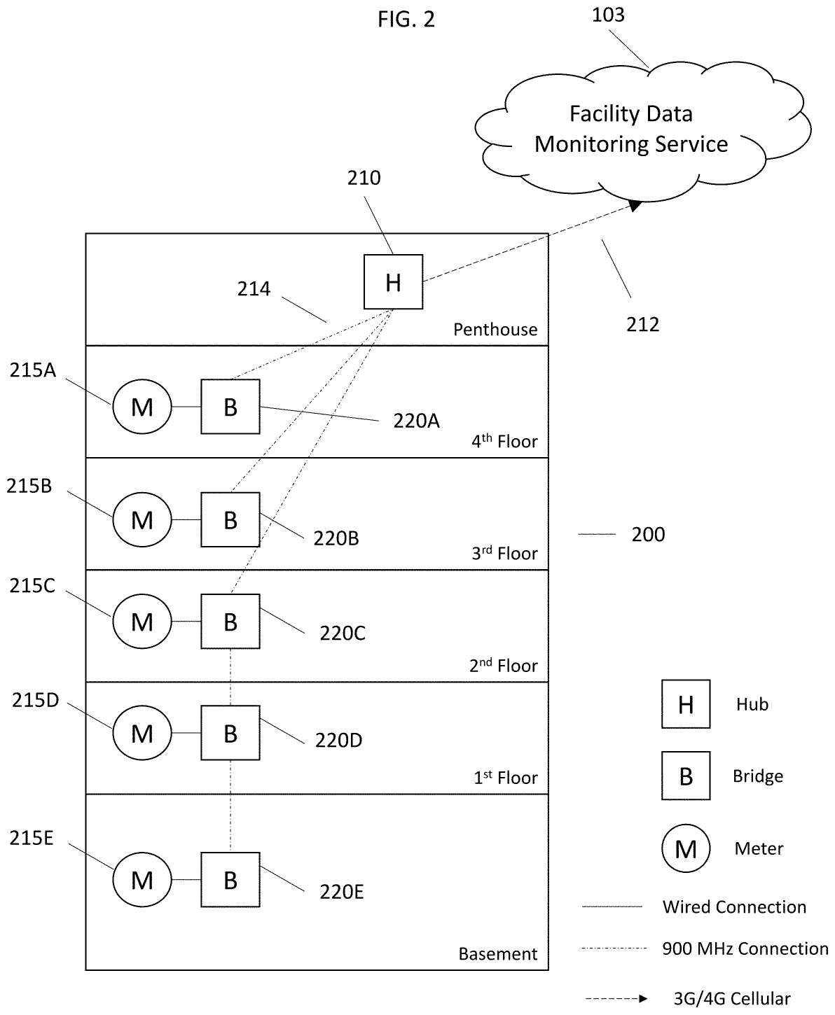

The operation of remote server 104, mobile device 105 with a mobile application used by a user 102 to self-install networking equipment and configure a building for remote facility data monitoring is described further below with respect to FIG. 1B and further examples in FIGS. 2-7.

FIG. 1B is a flowchart diagram of a method for providing scalable installation of facility data monitoring in a building according to an embodiment (steps 107-190).

i. Self-Installation Kit and Mobile Application

First, self-installation kit 108 is provided to a user 102 (step 107). Kit 108 includes a number of hubs and bridges needed to carry out a self-installation for a building. For example, kit 108 may include one or more hubs and bridges depending on the size of a building including the number of floors and the square area of floor space to be covered, and the number of meters, equipment, or environmental sensors used in the building. In one embodiment, at least one hub is self-installed in each building. For example, a hub may be placed at a location with at least good or the best cellular connectivity. One or more bridges are self-installed depending upon the number of facility equipment to monitor. In one feature, one bridge is provided for each piece of facility equipment. A hub is provided to communicate with nearby bridges depending upon signal strength, building materials, or distance. In this way, a bridge forms a wireless communication from distant meters to a hub. In one example, bridge(s) and hub(s) are installed at different locations such that the bridges are placed no more than four floors apart from a nearest bridge or hub. Bridges farther than four floors from a hub can be coupled to (such as daisy-chained) to a bridge within four floors. Four floors is an example and in general another predetermined distance can be used. Multiple hubs can be used for buildings with a greater numbers of floors, larger floor space or to handle larger numbers of bridges depending upon a particular configuration.

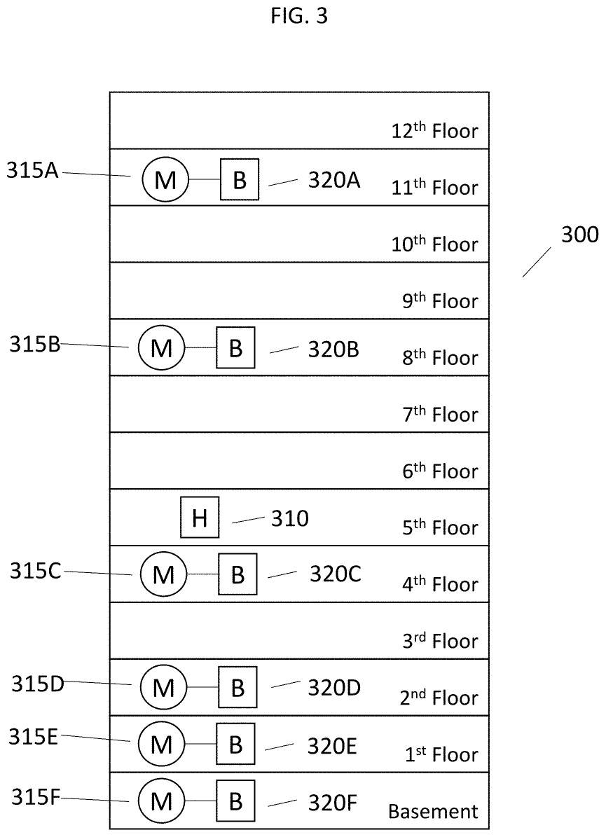

In the example shown in FIG. 2, building 200 includes a basement, four floors and a penthouse or top floor. Building 200 has five meters 215A-E installed at different locations (one each on the basement and first four floors) as shown. Kit 108 may include one hub 210 and five bridges 220A-220E. In the example shown in FIG. 3, a building 300 includes a basement and twelve floors. Building 300 has six meters 315A-F installed at different locations (e.g., 11th, 8th, 4th, 2nd, 1st floors and basement). Kit 108 then may include one hub 310 and six bridges 320A-320E.

These building examples are illustrative and not intended to be limiting. More or less meters may used on each floor including the top floor or basement as desired or for any sub-metering application. For example, where energy usage is desired to be detected in different units for different tenants or in areas where more energy is likely to be used, such as near appliances or HVAC systems, meters may be used to sense energy usage in a building with more granularity. Moreover, the examples in FIGS. 2-3 show meters labeled with an M. These meters can include, but are not limited to, one or more meters, equipment, and/or environmental sensors used in the buildings 200, 300 to support utility, energy, equipment, and/or environmental monitoring.

User 102 also initiates the mobile application on mobile device 105 (step 109 of FIG. 1B). For example, the mobile application can be opened and a display screen can be output by the mobile application to user 102. As shown in FIG. 4A, an initial display screen 402 presented may show building location information where the user 102 is currently located at the building to perform the self-installation. The mobile application can use the current location detected by the mobile device through one or more geolocation detection techniques, such as cell tower triangulation or GPS, to identify a building location where the mobile device is located during self-installation. Buttons may be provided in a user-interface to allow a user to select to view a dashboard, optimize facility operations, or add notes on the self-installation. Additional display areas 404 may be provided to show relevant images or text or other information (FIG. 4B). A menu icon may be selected in screen 402 to allow a user to view and select additional items (Devices & Equipment, My Tasks, Settings, Support and LogOut) as shown in display panel 406 in FIG. 4C. In one example, by selecting Devices & Equipment, a user can use the mobile application to navigate to or view a display panel 408 that automatically lists all currently connected devices at the location of the building in which new equipment is to be self-installed (FIG. 4D). The mobile application can use the current location detected by the mobile device through one or more geolocation detection techniques, such as cell tower triangulation or GPS, to identify a building location where the mobile device is located during self-installation and to search for previously connected devices in the building based on the detected geolocation. The connected devices can be found by searching locally stored information on the mobile device and/or by sending a search request to remote server 104.

The connected devices can include, but are not limited to, previously installed equipment from the same or different manufacturers. For example, as shown in display screen 408 of FIG. 4D, connected devices can include meters (such as an electric utility meter from Pepco), sensors (such as a vibration sensor from Aquicore Inc.), transmitters (such as one from Aquicore Inc.), and/or submeters (such as one from Aquicore Inc.). Note display screen 408 can also optionally display other nearby equipment (such as an Obvius gateway device) to user, if helpful for information purposes, even if the equipment is not to be included in the actual self-installed network.

ii. Self-Installing Facility Data Monitoring Components from Kit

Once a user has received a number of hubs and bridges from kit 108, according to a feature of the present disclosure, a user can proceed to self-install the facility data monitoring components (steps 110, 120, and 130).

### a. Self-Installation of Hub

In step 110, a user can self-install a hub. In one example, a user can position the hub at a desired location, attach a power supply to the hub, and attach the hub to a surface, such as a wall or table, with fasteners. An antenna may also be attached to the hub if needed. For example as shown in FIG. 2 a hub 210 can be on a top floor for best cellular communication. In the example of FIG. 3 a hub 310 can be on a middle floor (5^{th} floor) to support good cellular communication as well as communication with bridges on other floors above and below the hub.

If desired, according to a further feature, a user can access mobile application on mobile device 105. The mobile application may provide to a user in a display screen or other user-interface element an option to select a hub device that corresponds to the hub being installed. For example, the mobile application may provide a drop down menu or listing that enables a user to select the type of hub being installed. A series of instructions can then be displayed to the user to facilitate self-installation of the hub.

For example, as shown in FIG. 4E, a display screen 410 can be provided by the mobile application. Display screen 410 provides information about hub set up and can include a control button marked Get Started or Continue to allow a user to request further set up instructions for self-installing the hub. The further set up instructions can appear in one or more subsequent display screens. For example, display screen 412 can instruct the user on how to insert the power supply to the hub and power on (FIG. 4F). Display screen 414 can instruct the user on how to attach the hub to a surface such as a wall (FIG. 4G). A further display screen (not shown) can instruct the user on how to attach an antenna. Other information can provide guidance on placement of the hub with respect to signal strength, power, security or other set up considerations.

Once the hub is powered, mobile device 105 can communicate with the hub over a wireless link, such as, a short-range Bluetooth® link (or BTE) or other type of wireless link. In one embodiment, the mobile application on mobile device 105 is connected with the hub device (step 112). Once connected, the mobile application can automatically receive or ascertain hub device information, such as, a MAC address, manufacturer type, and/or product type over the wireless link. This hub device information can be displayed to user 102 for informational purposes or for confirmation by the user. An indication that the hub device has been detected can be provided to user 102 in a display screen 416 as shown in FIG. 4H.

Further steps can be carried out to register and provision the self-installed hub device with the facility data monitoring service 103 (step 170). For example, mobile device 105 can be coupled to communicate with remote server 104 over a wireless link, such as, cellular (e.g., 3G/4G/LTE/5G), wireless networking such as Wifi, or other link supported by mobile device 105. The mobile application on mobile device 105 can be used to enable a user to provide information needed by self-installation manager 160 to register the hub device with service 103. For example, the mobile application can send a unique identifier of the hub device self-installed by the user to remote self-installation manager 160. For example, the unique identifier may be an Ethernet MAC address. Other registration information pertaining to the hub device can also be provided such as manufacturer name, product type, and model number. The mobile application can display a screen indicating registration is being carried out by the service 103. Other display screens (not shown for brevity) can be provided for a user to authorize registration or allow sending of a MAC address and other registration information. Different user interface elements (text box inputs, voice activated commands, touch screen inputs, menus, etc.) can be used to allow a user to input data or control selection to facilitate registration.

A control button can be provided to enable a user to check a network connection status between the hub and the Internet or other network that can access remote server 104 (see FIG. 4H). As shown in the example of FIG. 41, a mobile application may communicate over a short-range link (such as BTE link) to the hub when it is powered on. The mobile application may query the hub over a short-range link for the hub's cellular signal strength. A display 418 may indicate the mobile application is looking for devices (i.e. remote server 104). When server 104 is found, self-installation manager 160 can send a mesh identification (mesh ID) associated with the self-installed hub to the mobile application. A display screen 420 can be provided by the mobile application to display a network connection status of the hub including cellular or carrier signal strength (FIG. 4J). A control button to allow a user to initiate provisioning may also be provided.

In step 170, the mobile application can communicate with remote self-installation manager 160 to carry out provisioning of the installed hub device in a new or existing network being monitored by service 103. For example, a display screen or other query can be provided to user 102 to enable a user to select whether hub is for a new network or is to be added to an existing network. If a new network is selected, remote self-installation manager 160 then provisions a new network having the self-installed hub in service 103 for the associated building. If an existing network is selected, remote self-installation manager 160 then provisions an existing network in service 103 for the associated building by adding the self-installed hub to the existing network. A record (or card) is created and stored in database 165 which represents a new device (the hub being self-installed) is found. Self-installation manager 160 can send a mesh identification (mesh ID) associated with the self-installed hub to the mobile application. The mesh ID allows the hub (and other devices and equipment) to be associated with a network topology. A display screen 422 may be shown to user 102 to indicate provisioning is underway (FIG. 4K). A further display screen 424 may also be presented to user 102 to indicate successful addition of a hub, connection status, signal strength, MAC address, and serial number information (FIG. 4L). Further control buttons may be provided to allow a user to add bridges or meters in a self-installation process (FIG. 4L).

### b. Self-Installation of Bridge

In step 120, a user can self-install a bridge. In one example, a user can position the bridge near a meter at a desired location and attach the hub to a surface, such as, a wall or table with fasteners. For example as shown in FIG. 2 a bridge 220A can be on a fourth floor near meter 215A and within range to communicate with hub 210 over a 900 Mhz connection. In the example of FIG. 3, a bridge 320A can be on an 11^{th} floor near meter 315A if within range to communicate with hub 310 on the 5^{th} floor over a 900 Mhz connection.

A power supply can be connected by the user to the bridge. An antenna may also be attached to the bridge if needed. Depending upon the type of bridge, one or more meters may be connected. A meter near the bridge is connected to the bridge. In further features, the meter can be connected via pulse outputs, a serial communication protocol, such as a Modbus protocol, or a data communication such as a BACnet protocol.

If desired, according to a further feature, a user can access mobile application on mobile device 105. As shown in FIG. 4M, the mobile application may provide information about bridge set up and installation to a user in a display screen 426. The mobile application may also provide to a user in a display screen or other user-interface element an option to select a bridge device that corresponds to the bridge being installed. For example, the mobile application may provide a drop down menu or listing 428 that enables a user to select the type of bridge being installed (FIG. 4N). A series of instructions can then be displayed to the user to facilitate self-installation of the bridge. For example, the instructions can be output to a user in text form with images or video, and/or audio output. A further panel 430 may be displayed to allow a user to further add meters connected to the self-installed bridge (FIG. 40).

In step 122, connection of the bridge to the meter is verified. The verification can depend upon a type of meter. For example, if the meter is a pulse meter, the bridge may verify that it is receiving pulses. The bridge may output a signal to an indicator to indicate whether or not a connection is in place and pulses are received. The indicator can be an indicator light, such as, one or more LEDs, on the bridge, or another type of visual, audible, or tactile indicator. The bridge may also output the signal to the mobile application to display a verification indication on the mobile device. In another example, if a meter is a as a MODBUS meter, the bridge may send Amperage, Voltage, and/or Power Factor readings to the mobile application. The mobile application can run logic and perform checks to ensure the values of the readings are within proper respective ranges. In one example, the mobile application can perform this connection verification offline without an Internet connection. This essentially commissions the meter in real time and without an internet connection. This is helpful if self-installation is being carried out in difficult to reach or interior locations of a building with poor signal strength.

In step 180, an inventory of installed meters can be performed and a new meter added. In one example, information identifying meter(s) coupled to the self-installed bridge is added to an inventory of connected devices.

In one embodiment, information on a meter being added to a self-installed bridge can be carried out through the mobile application, as shown in FIGS. 4P-4T as art of commissioning meters associated with the self-installed bridges. This can be carried out in a separate commissioning step 150 to commission meters. In FIG. 4P, a display screen 432 allows a user to select from recent meter types, if any, or to select by type of utility (electric, water, gas or steam). Once a meter or type of meter is selected, user may identify the type of connection method of the meter to the hub in a display screen 434 (FIG. 4Q). A display screen 436 can be presented to verify meter connection and perform a meter connection test (FIG. 4R). For example, the mobile application can communicate with the networked devices (hub or bridges) over a short-range link (such as a BTE link) to verify a meter connection. When a meter is working, a display screen 438 can be presented to indicate the meter is working and present meter information (FIG. 4S). Control buttons can be provided to add another meter or view more data about the added meter. When view data is selected, a display screen 440 can be presented to allow a user to view or add more meter data for inclusion in network information (FIG. 4T). A Device Type field can be automatically populated with recent information to save user text entry. A Networking Device field can include a drop down list to select from or automatically populated with data about a hub or bridge being self-installed.

For example, the meter information can be sent by the self-installed bridge to the mobile application on the mobile device. A user can confirm the meter information. The mobile application can then send the meter information to self-installation manager 160 at remote server 104 (step 124). Self-installation manager 160 can then add the new meter information to an inventory of connected devices stored in storage database 165 (step 180).

In step 130, the self-installed bridge is further connected to the self-installed hub installed in step 110. For example, the self-installed bridge can be communicatively coupled over a wireless link to the hub. In one example a self-installed hub communicates with remote server 104 in a cloud platform using a 4G cellular connection. Bridges communicate with one or more hubs using a 900 MHz wireless mesh network. Bridges and hubs can communicate over Bluetooth® link with the mobile application for self-installation.

A check is made to evaluate whether the hub is visible to the bridge (step 135). If the hub is visible to the bridge (that is, within signal range), the control proceeds to create a network topology (step 190) that includes the bridge. If the hub is not visible to the bridge (that is, within signal range), then a user may move the bridge to a different location until the bridge can be connected to the hub (step 140) and a connected hub is visible. For example, within range could be within one or more hops in a mesh network. Each hop in a mesh network has a signal strength (measured in RSSI). There can be multiple paths to the hub in the mesh network and the bridge will take the most optimal path or other acceptable path.

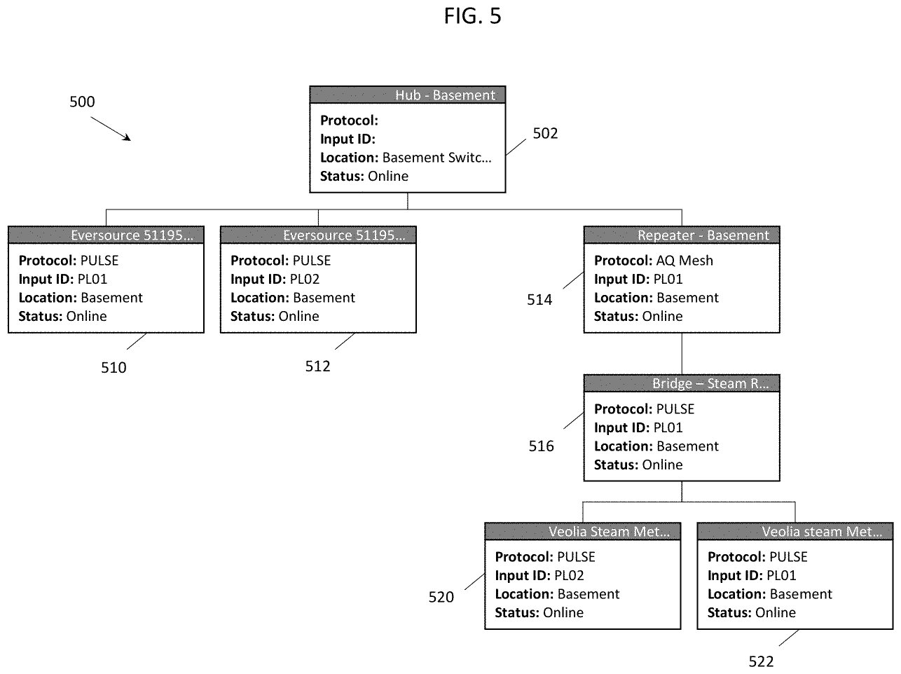

In step 190, the network topology created includes the self-installed bridge. A network topology is a data structure, such as, data records organized in a hierarchical structure representative of the network topology. FIG. 5 shows an example of a network topology 500 that is made up of records 502, 510, 512, 514, 516, 520 and 522 for facility data monitoring components in a self-installed network. The network topology 500 also represents the structure of the example network made up of a hub coupled to two pulse type bridges and a repeater coupled to a third bridge in turn coupled to two meters.

Each record includes data fields such as protocol, input ID, location, and status. Protocol is used to indicate a type of protocol (e.g, pulse or serial) used by a bridge or meter. Input ID is used to indicate a particular input terminal (e.g, PL01 or PL02) when needed for certain polarity sensitive arrangements. Location refers to the location of the device represented by the record and can be a location label assigned by the user for a building (such as basement) or can be a geolocation or other type of location identifier. Status indicates the status of a device in the network as being online or offline, that is available for use or not in remote facility data monitoring service 103.

Record 502 corresponds to a hub and has information indicating the hub is located in a basement switch and has a status online. Records 510 and 512 correspond to bridges. Record 510 has information indicating a bridge (made by Eversource, model type 51195) having pulse ID 01 is located in a basement and has a status online. Record 512 has information indicating another bridge (made by Eversource, model type 51195) having pulse ID 02 is located in a basement and has a status online.

Record 514 corresponds to a repeater. Record 514 has information indicating the repeater having pulse ID 01 is located in a basement and has a status online. Record 516 corresponds to a bridge. Record 516 has information indicating a bridge (made by Steam R . . . ) having pulse ID 01 is located in a basement and has a status online.

Records 520 and 522 correspond to respective meters coupled to the third bridge represented by record 516. Record 520 has information indicating a meter (made by Veolia Steam Met . . . ) having pulse ID 02 is located in a basement and has a status online. Record 522 has information indicating a meter (made by Veolia Steam Met . . . ) having pulse ID 01 is located in a basement and has a status online.

In an embodiment, in step 190, user 102 can use a mobile application in communication with the self-installation manager 160 to create a network topology that includes self-installed bridges and hubs. For example, the mobile application may allow a user to identify and configure links between hubs and bridges, hubs and repeaters, and between meters and bridges in a network. One or more display screens and user-interface elements can be used by the mobile application (in communication with self-installation manager 160) to allow a user to create or edit a network topology, add facility data monitoring components, and identify and configure links. Storage database 165 can be used to store information on the created network topology 500 including records 502, 510, 512, 514, 516, 520 and 522.

Self-installation systems and methods described here have many advantages compared to conventional installation. First, self-installation can be carried out in realtime as installation is being done on site. This can occur in less than a day and even in hours or minutes. Moreover, the self-installation can be carried out by a user using a mobile application and a self-installation kit. The self-installation is scaleable and highly configurable in that new bridges and hubs can be added as needed to existing meters and added to a new or existing network topology in a facility data monitoring service. This allows a self-installation to be carried out as greater coverage or granularity of metering is needed. It also allows more flexibility when costs are incurred and scheduled. The self-installation is universal in that it can be carried out for the same or different types of equipment. The self-installation can also be carried out quickly on the order of days or minutes rather than weeks.

### C. Commissioning

A commissioning process is a set of steps done to ensure that the hardware (hub or bridge) installed to read data from a meter is installed correctly. This allows the monitoring service to determine the actual load being monitored. There are different commissioning steps for each protocol supported (ModBus, Pulse, Bacnet).

### Pulse

Step 1: Created Meter—The basic first step of using the Aquicore to digitally inventory the meter.

Step 2: Web Enabled Meter—The meter is connected to a networking device, either a Hub or Bridge.

Step 3: Receiving Data—Data is being received and ingested properly for this meter. For this to happen there needs to be a networking device connected and provisioned in the platform wherein the platform receives packets from the device.

Step 4: Manual Reading #1—A manual reading may be taken through the mobile application as part of the self-installation process or at any time a user selects to take a reading through the mobile application. The manual reading allows data validation to occur. For example, in order to perform data validation of data reported to the remote online monitoring system, a comparison of data the platform received with manual readings (physically reading values from the meter) can be done. This way the remote online monitoring system can be sure the amount of usage reported is accurate (e.g. within 2% difference). In one example, two manual readings are carried out. This step is for taking the first manual readings using the platform.

### ModBus

Several steps may be carried out for a MODBUS type of meter. In one example, amperage has to be greater than 1% of the rated current transformer (CT) size, e.g. for a 20 Amp CT one should see 0.2 Amps.
1. Balanced Amperage—across each phase (3 phases).
2. Power Factor greater than 0.7 on all phase—the power one can actually use is the power factor.
3. CT Size installed matches meter configuration and matches platform configuration. To ensure that the CT size is actually correct in the installation, a user takes a picture. This is a further feature of a self-installation as it allows later access to images of the self-installation.
4. Configure meters voltage level (e.g. high=480V, low=208V) and check to make sure voltage meets expected value between the different phases.
5. One manual reading can be used to validate kWh on the meter to make sure it matches the value of kWh in the online service platform for the same timestamp.

### BACNet

1. In a BACNet type of meter, one manual reading is taken to compare with the platform value at the same time stamp. Only one reading need be done because one can confirm that the platform receives and stores the data that the building management system (BMS) is sending.

### D. Example Facility Data Monitoring Service

Once the self-installation as described above is carried out, facility data monitoring information on the self-installed network in a building can be provided through facility data monitoring service 103. This facility data monitoring information can include analytics on usage in a building as detected by the meters and communicated by the bridges and hub to the facility data monitoring service 103. Moreover, any authorized user can access the facility data monitoring service 103 from a computing device to remotely monitor and/or manage energy usage at the building. In one embodiment, facility data monitoring service 103 can include, but is not limited to, a facility data monitoring service available from Aquicore Inc. In further embodiments, facility data monitoring service 103 can include, but is not limited to, a configurable data management service described in appl. Ser. No. 14/449,893 incorporated in its entirety herein by reference.

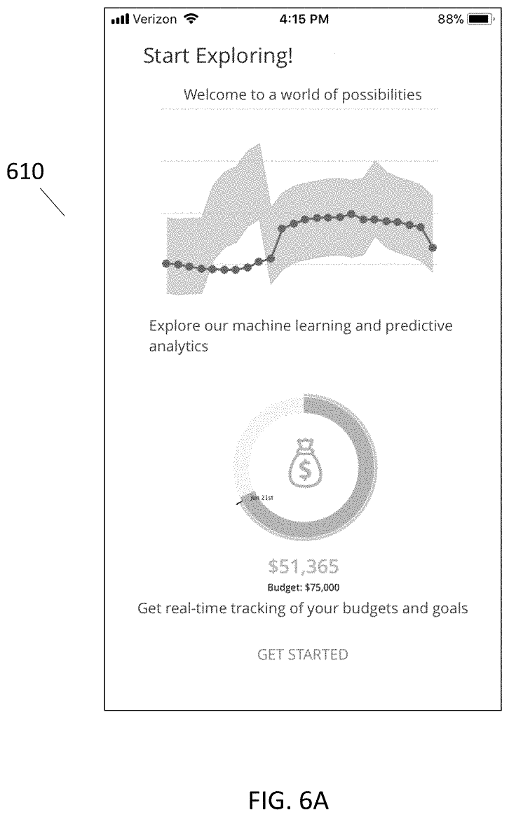

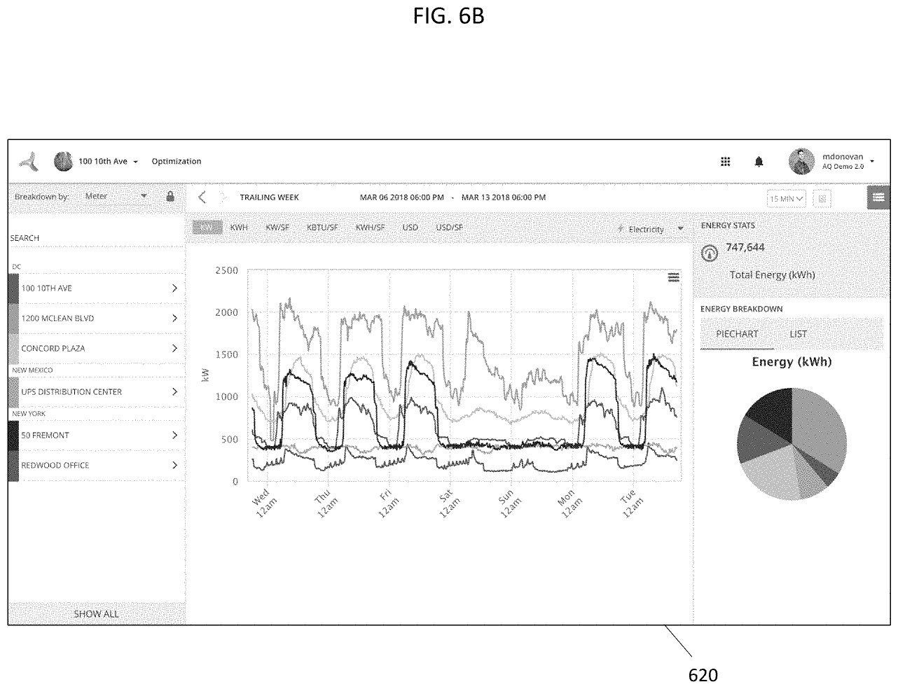

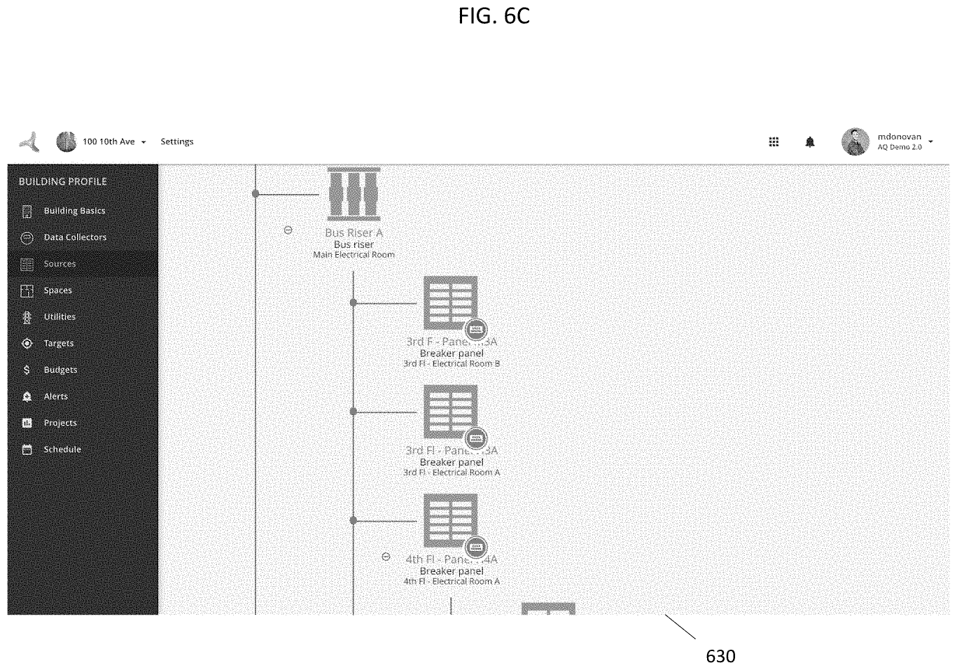

FIG. 6A shows an example welcome “Start Exploring” screen display 610 that may be output by a mobile application on a mobile device after set up and registration of devices in an installation. This screen can be accessed through a browser or other mobile application on the mobile device that is used to access facility data monitoring service 103.

FIG. 6B shows an example facility data monitoring screen display 620 that may be generated for a user (for example at a laptop or desktop computing device with a larger display screen) to facilitate facility data monitoring of an installation. This screen can be accessed through a browser or other application on a computing device that is used to access facility data monitoring service 103.

FIG. 6C shows an example dynamic riser diagram that may be generated for a user to facilitate management of the facility data monitoring of a network with self-installed facility data monitoring components as described herein.

In a further feature, system 100 can provide for configurable building energy management using meters coupled to bridges, according to an embodiment. Since facility data monitoring service 103, remote to building 101, can perform processing of measured raw energy data received from the sensors in meters, a user does not need to install additional on-site servers in building 101. Similarly, besides transmission of measured raw or processed energy data from the sensors in meters through bridges and a hub to remote server 104, no additional integration work is needed for the hardware installation. The simplified and flexible installation of sensors in building 101 illustrates a universal hardware deployment scheme of system 100, with which a scalable installation solution satisfies different needs of different users, regardless of the managed building's age, size, or energy system.

In one embodiment, facility data monitoring service 103 can also provide a centralized platform for managing energy usage. Facility data monitoring service 103 can help users of the service to make fast cost-saving decisions, centralize oversight, improve staff productivity, track project return on investment (ROI), and enhance tenant satisfaction. Facility data monitoring service 103 can host a set of energy management software modules that are configurable for different users subscribed to the facility data monitoring service. Based on the user configuration, a user may subscribe to one or more of the set of energy management modules including, but not limited to, a building optimization module, portfolio benchmarking module, project tracking module, energy star compliance module, tenant billing module, and public engagement module.

Meters may be any commercial off-the-shelf energy meters. When the meters are coupled to bridges in a self-installation as described herein, the data from the meters related to energy usage can be captured. Meters come in different types and can have different types of sensors.

For example, some sensors can measure voltage or current of a device or a building. In another example not intended to be limiting, sensors can be located at a common location to measure voltage and current of a device or a building allowing true power, which a function of voltage times current, to be determined in real-time. In another feature, separate sensors can be located at different locations to measure voltage and current of a device or a building. Data from the sensors is sampled at periodic time intervals that still allows true power to be determined in real-time. In one example such sampling of the data sensed for voltage and current can be carried out on the order of seconds, milliseconds or less depending upon available computing power so that true power consumption of a device or a building can be obtained in real-time.

The meters installed in building 101 (see FIG. 1A) may be for building level metering or sub-metering. For example, meters can measure building-level energy usage of building 101. Meters can also be sub-metering sensors. Sub-metering may provide measurement at the tenant level. For example, sub-metering may be installed to measure energy usage of a particular tenant. Sub-metering may also provide energy measurement at the equipment level. For example, sub-metering may be installed to measure energy usage of a particular electrical device.

Facility data monitoring service 103 may include a web server (not shown). Web server may be configured to accept requests for resources from client devices, such as web pages and send responses back to client devices. Any type of web server may be used including, but not limited to, Apache available from the Apache Project, IIS available from Microsoft Corp., nginx available from NGINX Inc., GWS available from Google Inc., or other type of proprietary or open source web server. A web server may also interact with remote server 104 and self-installation manager 160. A user can mobile device 105 or other computing device to configure and access services provided by facility data monitoring service 103. Example computing devices include, but are not limited to, any type of processing device including, but not limited to, a computer, workstation, distributed computing system, embedded system, stand-alone electronic device, networked device, mobile device (such as a smartphone, tablet computer, or laptop computer), set-top box, television, or other type of processor or computer system.

Mobile device 105 may include a web browser for communicating with a web server. Any type of browser may be used including, but not limited to, Internet Explorer available from Microsoft Corp., Safari available from Apple Corp., Chrome browser from Google Inc., Firefox, Opera, or other type of proprietary or open source browser. A browser is configured to request and retrieve resources, such as web pages that provide options to configure and carry out aspects of self-installation viewed by the user using a web browser.

After configuration, the user may access subscribed energy management modules by using a web browser. For example, the user may use a web browser to view energy management information (e.g., energy data, graphs, or charts) prepared by a subscribed energy management module. The web browser may send a HTTP request to a web server. The energy data, graphs, or charts may be transmitted to web browser via HTTP responses sent by web server.

A user may also access subscribed energy management modules by using a standalone client application on a client computing device (e.g., mobile device 105). In one embodiment, a client application communicates directly with a subscribed energy management module to obtain the energy data prepared by the subscribed energy management module. In another embodiment, a client application communicates with subscription manager to obtain the energy management information prepared by the subscribed energy management module. In some embodiments, client application requests and receives energy data through RESTful API. In other embodiments, a client application may utilize other communication architectures or protocols to request and receive the energy management information. These communication architectures or protocols include, but are not limited to, SOAP, CORBA, GIOP, or ICE. The display of energy data by standalone client application may be further customized depending on the user's special needs.

The non-limiting example in FIG. 1A shows that wireless sensors (also called meters) in building 101 may transmit raw energy data directly to facility data monitoring service 103 through a bridge and a hub. In one alternative embodiment, wireless sensors in building 101 may connect to a hub wirelessly, and the hub may transmit raw energy data to facility data monitoring service 103. In one example not intended to be limiting, meters in building 101 through bridges may be interconnected with each other in a wireless mesh network. The benefit of the wireless mesh network is that a wireless sensor outside the wireless range to the gateway may nevertheless use other wireless sensors in the wireless mesh network to relay raw energy data to the gateway or hub.

### D. Example Computer System

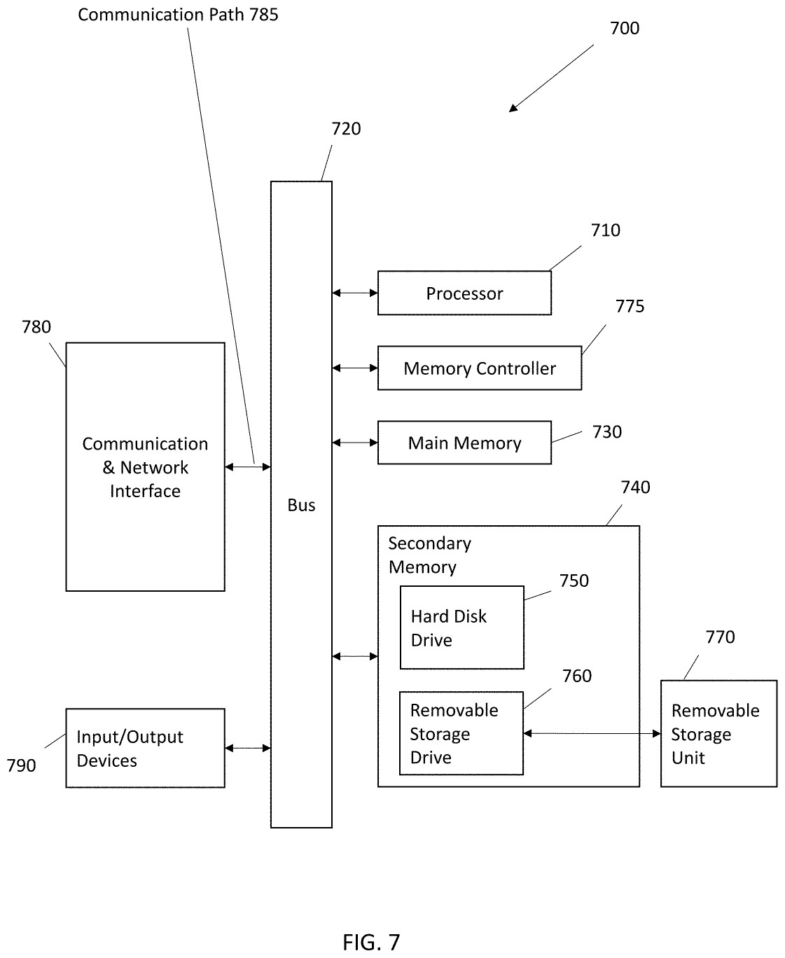

Various aspects of the disclosure can be implemented on a computing device by software, firmware, hardware, or a combination thereof. In one embodiment, remote server 104 having self-installation manager 160 can be implemented on a computing device by software, firmware, hardware, or a combination thereof. In one embodiment, the mobile application described above can be implemented by software, firmware, hardware, or a combination thereof on a computing device. FIG. 7 illustrates an example computer system 700 in which the contemplated embodiments, or portions thereof, can be implemented as computer-readable code. For example, the methods illustrated by flowcharts described herein can be implemented in system 700. Various embodiments are described in terms of this example computer system 700. After reading this description, it will become apparent to a person skilled in the relevant art how to implement the embodiments using other computer systems and/or computer architectures.

Computer system 700 includes one or more processors, such as processor 710. Processor 710 can be a special purpose or a general purpose processor. Processor 710 is connected to a communication infrastructure 720 (for example, a bus or network). Processor 710 may include a CPU, a Graphics Processing Unit (GPU), an Accelerated Processing Unit (APU), a Field-Programmable Gate Array (FPGA), Digital Signal Processing (DSP), or other similar general purpose or specialized processing units.

Computer system 700 also includes a main memory 730, and may also include a secondary memory 740. Main memory may be a volatile memory or non-volatile memory, and may be divided into channels. Secondary memory 740 may include, for example, non-volatile memory such as a hard disk drive 750, a removable storage drive 760, and/or a memory stick. Removable storage drive 760 may comprise a floppy disk drive, a magnetic tape drive, an optical disk drive, a flash memory, or the like. The removable storage drive 760 reads from and/or writes to a removable storage unit 770 in a well-known manner. Removable storage unit 770 may comprise a floppy disk, magnetic tape, optical disk, etc. which is read by and written to by removable storage drive 760. As will be appreciated by persons skilled in the relevant art(s), removable storage unit 770 includes a computer usable storage medium having stored therein computer software and/or data.

In alternative implementations, secondary memory 740 may include other similar means for allowing computer programs or other instructions to be loaded into computer system 700. Such means may include, for example, a removable storage unit 770 and an interface (not shown). Examples of such means may include a program cartridge and cartridge interface (such as that found in video game devices), a removable memory chip (such as an EPROM, or PROM) and associated socket, and other removable storage units 770 and interfaces which allow software and data to be transferred from the removable storage unit 770 to computer system 700.

Computer system 700 may also include a memory controller 775. Memory controller 775 includes functionalities to control data access to main memory 730 and secondary memory 740. In some embodiments, memory controller 775 may be external to processor 710, as shown in FIG. 7. In other embodiments, memory controller 775 may also be directly part of processor 710. For example, many AIVID™ and Intel™ processors use integrated memory controllers that are part of the same chip as processor 710 (not shown in FIG. 7).

Computer system 700 may also include one or more communications and network interfaces 780. Communication and network interface 780 allows software and data to be transferred between computer system 700 and external devices. Communications and network interface 780 may include a modem, a communications port, a PCMCIA slot and card, or the like. Software and data transferred via communications and network interface 780 are in the form of signals which may be electronic, electromagnetic, optical, or other signals capable of being received by communication and network interface 780. These signals are provided to communication and network interface 780 via a communication path 785. Communication path 785 carries signals and may be implemented using wire or cable, fiber optics, a phone line, a cellular phone link, an RF link or other communications channels.

The communication and network interface 780 allows the computer system 700 to communicate over communication networks or mediums such as LANs, WANs the Internet, etc. The communication and network interface 780 may interface with remote sites or networks via wired or wireless connections.

In this document, the terms “computer program medium,” “computer-usable medium” and “non-transitory medium” are used to generally refer to tangible media such as removable storage unit 770, removable storage drive 760, and a hard disk installed in hard disk drive 750. Signals carried over communication path 785 can also embody the logic described herein. Computer program medium and computer usable medium can also refer to memories, such as main memory 730 and secondary memory 740, which can be memory semiconductors (e.g. DRAMs, etc.). These computer program products are means for providing software to computer system 700.

Computer programs (also called computer control logic) are stored in main memory 730 and/or secondary memory 740. Computer programs may also be received via communication and network interface 780. Such computer programs, when executed, enable computer system 700 to implement embodiments as discussed herein. In particular, the computer programs, when executed, enable processor 710 to implement the disclosed processes, such as the steps in the methods illustrated by flowcharts discussed above. Accordingly, such computer programs represent controllers of the computer system 700. Where the embodiments are implemented using software, the software may be stored in a computer program product and loaded into computer system 700 using removable storage drive 760, interfaces, hard drive 750 or communication and network interface 780, for example.

The computer system 700 may also include input/output/display devices 790, such as keyboards, monitors, pointing devices, touchscreens, etc.

It should be noted that the simulation, synthesis and/or manufacture of various embodiments may be accomplished, in part, through the use of computer readable code, including general programming languages (such as C or C++), hardware description languages (HDL) such as, for example, Verilog HDL, VHDL, Altera HDL (AHDL), or other available programming and/or schematic capture tools (such as circuit capture tools). This computer readable code can be disposed in any known computer-usable medium including a semiconductor, magnetic disk, optical disk (such as CD-ROM, DVD-ROM). As such, the code can be transmitted over communication networks including the Internet. It is understood that the functions accomplished and/or structure provided by the systems and techniques described above can be represented in a core that is embodied in program code and can be transferred to hardware as part of the production of integrated circuits.

The embodiments are also directed to computer program products comprising software stored on any computer-usable medium. Such software, when executed in one or more data processing devices, causes a data processing device(s) to operate as described herein or, as noted above, allows for the synthesis and/or manufacture of electronic devices (e.g., ASICs, or processors) to perform embodiments described herein. Embodiments employ any computer-usable or -readable medium, and any computer-usable or -readable storage medium known now or in the future. Examples of computer-usable or computer-readable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nano-technological storage devices, etc.), and communication mediums (e.g., wired and wireless communications networks, local area networks, wide area networks, intranets, etc.). Computer-usable or computer-readable mediums can include any form of transitory (which include signals) or non-transitory media (which exclude signals). Non-transitory media comprise, by way of non-limiting example, the aforementioned physical storage devices (e.g., primary and secondary storage devices).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described exemplary embodiments, but should be defined only in accordance with the following claims and their equivalents.

What is claimed is:

1. A method for providing scalable self-installation of facility data monitoring in a building having one or more meters, equipment, and/or environmental sensors through an application and a user-interface on a mobile device coupled to communicate over a network to a remote online data monitoring service, comprising:
installing a hub configured to have a first wireless communication link for communicating over the network to a remote online data monitoring service and a second wireless communication link for communicating locally with the mobile device;
connecting the installed hub with the mobile device over the second wireless communication link;
using the application on the mobile device to communicate with the hub to verify the presence of the installed hub and check a signal strength of the hub for the first wireless communication link of the hub over the network to the remote online data monitoring service;
installing at least one bridge including coupling the at least one bridge to one or more meters;
using the application on the mobile device to communicate with the at least one installed bridge to verify the connection of each meter;
connecting the at least one installed bridge to the installed hub over one or more wireless communication links to form a network of devices;
using the application on the mobile device to communicate with the at least one installed bridge to verify the connection of each installed bridge with the installed hub; and
using the application on the mobile device to communicate with the remote online data monitoring service to initiate provisioning of the installed hub and the at least one installed bridge with the online data monitoring service.

2. The method of claim 1, further comprising using the application on the mobile device to communicate with the remote online data monitoring service to:
generate an inventory of the one or more meters; and
create a network topology representing the installation of the hub and the at least one bridge and coupled meters in the building.

2. The method of claim 1, further comprising prior to the installing steps, providing a self-installation kit to a user, wherein the self-installation kit includes the hub and the at least one bridge.

3. A method for providing scalable self-installation of facility data monitoring in a building having one or more meters through an application and a user-interface on a mobile device coupled to communicate over a network to a remote online data monitoring service, comprising:
enabling a user through a user-interface at the mobile device to enter information in response to the application on the mobile device communicating with the remote online data monitoring service to:
register with the remote online data monitoring service a hub and at least one bridge self-installed by a user in the building;
generate an inventory of the one or more meters; and
create a network topology representing the installation of the hub and the at least one bridge and coupled meters in the building.

4. A method for configuring an online data monitoring service to accommodate a scalable self-installation of facility data monitoring in a building having one or more meters comprising, in response to self-installation information received over a network from an application at a mobile device, the steps of:
registering on the remote online data monitoring service a hub and at least one bridge self-installed by a user in the building;
generating on the remote online data monitoring service an inventory of the one or more meters; and
creating on the remote online data monitoring service a network topology representing the installation of the hub and the at least one bridge and coupled meters in the building.

5. A system for configuring an online data monitoring service to accommodate a scalable self-installation of facility data monitoring in a building having one or more meters comprising:
at least one processor configured to perform the following operations in response to self-installation information received over a network from an application at a mobile device:
register on the remote online data monitoring service a hub and at least one bridge installed in the building;
generate on the remote online data monitoring service an inventory of the one or more meters; and
create on the remote online data monitoring service a network topology representing the installation of the hub and the at least one bridge and coupled meters self-installed in the building by a user; and
a storage database that stores information representative of the registered hub and at least one bridge self-installed in the building, the generated inventory of meters, and the created network topology.

6. A system for providing scalable installation of facility data monitoring in a building having one or more meters, comprising:
a self-installation kit that includes a hub and at least one bridge; and
an application which can be downloaded over a network to a mobile device having a user-interface;
wherein a user through a user-interface at the mobile device can enter information in response to the application operating on the mobile device and communicating with a remote online data monitoring service to:
register with the remote online data monitoring service the hub and at least one bridge from the kit self-installed in the building by a user.

7. The system of claim 6, wherein the user through the user-interface at the mobile device can enter information in response to the application operating on the mobile device and communicating with a remote online data monitoring service to:
generate an inventory of the one or more meters; and
create a network topology representing the self-installation of the hub and the at least one bridge and coupled meters in the building.

8. The system of claim 7, wherein the meters comprise meters having different types of communication, whereby, the scalable installation of facility data monitoring in a building can be applied universally to remotely monitor energy from meters of different types.

9. The system of claim 8, wherein the different types of communication include pulse output signals and signals output according to a serial communication protocol.

10. The system of claim 8, wherein the meters comprise meters manufactured by different manufacturers.

11. A non-transitory computer-readable medium, having instructions stored thereon, that when executed by at least one processor, cause the at least one processor to perform operations for enabling a user to self-install facility data monitoring components for energy management of at least one building or project from a remote computing device through a data monitoring service hosted on a computer network, the operations including:
registering on a remote online data monitoring service a hub and at least one bridge self-installed in the building by a user;
generating on the remote online data monitoring service an inventory of the one or more meters; and
creating on the remote online data monitoring service a network topology representing the self-installation of the hub and the at least one bridge and coupled meters in the building.
